(19) United States
(12) Patent Application Publication
(10) Pub. No.: US 2016/0371462 A1
(43) Pub. Date: Dec. 22, 2016

(54) MEDICATION DISPENSING DEVICE AND METHOD

(71) Applicant: MedSentry, Inc., Westborough, MA (US)

(72) Inventors: Adam Robert WALLEN, Swampscott, MA (US); David BEAR, Wellesley, MA (US); William D. AMSDEN, Millbury, MA (US); Jerry Cotellessa, South Walpole, MA (US)

(21) Appl. No.: 15/185,621

(22) Filed: Jun. 17, 2016

Related U.S. Application Data
(60) Provisional application No. 62/181,617, filed on Jun. 18, 2015.

(51) Int. Cl. G06F 19/00; B65D 83/04; A61J 7/00; G05B 19/406

(52) U.S. Cl. CPC G06F 19/3462; G05B 19/406; B65D 83/0409; A61J 7/0076; G05B 2219/32287

(57) ABSTRACT

Devices, systems and methods for monitoring patient adherence to treatment regimens are described herein. In some embodiments, a medication dispensing system includes a medication dispensing device and a monitor. The medication dispensing device is configured to receive dose containers, and includes a dispensing mechanism that is operable to dispense at least one of the dose containers at a predetermined time based on a prescribed treatment regimen. Each of the dose containers defines an interior region configured to contain a plurality of individual medications. The medication dispensing device also includes an event detection system including a plurality of sensors configured to detect a change in status of the medication dispensing device and/or a change in the dose containers, and a control unit configured to operate the dispensing mechanism and the event detection system, and to communicate with a monitor (e.g., a remote server or any third-party monitor) and a user.

### CROSS-REFERENCE TO RELATED APPLICATIONS

This application claims priority to and the benefit of U.S. Provisional Patent Application Ser. No. 62/181,617, entitled “Medication Dispensing Device and Method,” filed Jun. 18, 2015, the disclosure of which is hereby incorporated by reference in its entirety.

### BACKGROUND

Embodiments described herein relate generally to devices, systems and methods for monitoring patient adherence to treatment regimens, and particularly to such a device that enhances patient adherence to a prescription medication regimen.

Adherence is commonly defined as the extent to which a patient complies with a clinician's recommended treatment regimen (e.g., by taking prescribed medications). Medication non-adherence contributes to 125,000 deaths annually in the United States, leads to 10-25% of hospital and nursing home admissions, and costs $300 billion annually in excess medical expenses.

Hospital costs due to patient non-adherence are estimated at $8.5 billion annually. With the recent intensive movement to cost sharing (e.g., Accountable Care Organizations), hospital systems face severe financial penalties for early re-hospitalizations based on medication non-adherence following discharge. Studies show that approximately 50% of the 2 billion prescriptions filled each year are not taken as prescribed. (J. A. Cramer et al., “How Often Is Medication Taken as Prescribed? A Novel Assessment Technique,” Journal of the American Medical Association (9 Jun. 1989)). Low adherence to prescribed treatments has been shown to undermine treatment benefits. (Sackett D L, Snow J C. The magnitude of adherence and non-adherence. In: Haynes R B, Taylor D W, Sackett D L, eds. Adherence in Health Care. Baltimore, Md.: Johns Hopkins University Press; 1979:11-22).

Another area where patient adherence is particularly essential is in drug clinical trials, because non-adherence can lead to erroneous data that can skew the results of the clinical trial. The motivation of clinical trial subjects to adhere to the prescribed drug regimen can be variable, leading to a higher rate of non-adherence. Since the cost of a single drug trial is generally in the range of billions of dollars, it is imperative to monitor and ensure adherence of the study subjects to the prescribed regimen.

Several studies have found that although systems and methods of enhancing compliance are available, such systems and methods are labor intensive and complex, thereby complicating dissemination and general usability. Thus, a majority of findings indicate that the full benefit of medications being prescribed is not being achieved due to low adherence levels (Haynes et al. 2002).

While the medication non-adherence problem has been clearly identified, the current monitoring/reminding systems do not provide a comprehensive solution that scales and addresses the multiple challenges to medication adherence. Thus, a need exists for improved and simplified devices, systems, and methods for monitoring and improving patient adherence to treatment regimens.

### SUMMARY

Devices, systems, and methods for monitoring and enhancing patient adherence to a prescription drug regimen are disclosed herein. In some embodiments, a medication dispensing system includes a medication dispensing device and a monitor. The medication dispensing device is configured to receive a plurality of dose containers, and includes a dispensing mechanism that is operable to dispense at least one of the plurality of dose containers at a predetermined time based on a prescribed treatment regimen. As described herein, each of the dose containers defines an interior region configured to contain a plurality of individual medications. The medication dispensing device also includes an event detection system including a plurality of sensors configured to detect a change in status of the medication dispensing device and/or a change in the plurality of dose containers, and a control unit configured to operate the dispensing mechanism and the event detection system, and to communicate with a monitor (e.g., a remote server or any third-party monitor) and a user.

### BRIEF DESCRIPTION OF THE DRAWINGS

FIG. 1 is a schematic illustration of a medication dispensing system according to an embodiment.

FIG. 2A is a side view of a dose container according to an embodiment.

FIG. 2B is a top view of a tray used in assembling a cartridge according to an embodiment.

FIG. 2C is an illustration of a quill for use in a cartridge according to an embodiment.

FIG. 2D is a perspective view of a cartridge according to an embodiment.

FIG. 3 is a cross-sectional view of a medication dispensing device according to an embodiment.

FIG. 4 is a perspective view of a medication dispensing device according to an embodiment.

FIG. 5 is a perspective view of a medication dispensing device according to an embodiment.

FIG. 6 is a perspective view of a medication dispensing device according to an embodiment.

FIG. 7 is a perspective view of a medication dispensing device according to an embodiment.

FIG. 8A is a perspective view of a tray forming an array of dose containers for use in a medication dispensing device according to an embodiment.

FIG. 8B is a bottom view of a strip of dose containers for use in a medication dispensing device according to an embodiment.

FIG. 8C is a perspective view of a removable basket for use in a medication dispensing device according to an embodiment in a first configuration.

FIG. 8D is a top view of the removable basket of FIG. 8C in a second configuration.

FIG. 9 is an illustration of a flow diagram of a method of using a medication dispensing system according to an embodiment.

### DETAILED DESCRIPTION

Devices, systems, and methods for monitoring and enhancing patient adherence to a prescription drug regimen are disclosed herein. In some embodiments, a medication dispensing system includes a medication dispensing device and a monitor. The medication dispensing device is configured to receive a plurality of dose containers, and includes a dispensing mechanism that is operable to dispense at least one of the plurality of dose containers at a predetermined time based on a prescribed treatment regimen. As described herein, each of the dose containers defines an interior region configured to contain a plurality of individual medications. The dose containers are a familiar form factor to patients, they are convenient to handle, and the dispensing of individual dose containers eliminates confusing that can be caused by multiple pouches of pills. The medication dispensing device also includes an event detection system including a plurality of sensors configured to detect a change in status of the medication dispensing device and/or a change in the plurality of dose containers, and a control unit configured to operate the dispensing mechanism and the event detection system, and to communicate with a monitor (e.g., a remote server or any third-party monitor) and a user.

In some embodiments, the medication dispensing system can be used as part of a system or method of monitoring patient adherence to a treatment regimen. The method can include notifying a patient that it is time to take a prescribed medication, determining if the patient has accessed (e.g., opened) a dispensing chamber, removed the dose container or containers from the dispensing chamber, and/or closed the dispensing chamber at a predetermined time of the day and/or week. When a user interacts with the medication dispensing device, for example, by removing a dose container at the appropriate time or loading a new medication cartridge or basket, a notification or message can be sent out to alert the user (e.g., a patient) and/or a monitor (e.g., a care giver, a family member, a call center, a pharmacy, and/or a doctor) that the user appears to be in compliance with their prescribed medication regimen. Similarly, if the user fails to interact with the medication dispensing device, for example, by not removing a dose container, or not reloading the medication dispensing device, a notification or message can be sent to the monitor to indicate that the user appears to be non-compliant. The notifications and alerts can include visual, audible and/or tactile indications to encourage adherence or warn of errors.

In some embodiments, the medication dispensing system can be used as part of a system or method of preventing deviations from a treatment regimen. The method can include determining if and when a patient has or has not removed the prescribed medication dosage at the prescribed time and day of the week. The method can also include determining if and when a patient deviates from the prescribed medication dosage (e.g. removing more or fewer than prescribed dosage or removing at a different frequency) when interacting with the medication dispensing device, ensuring that any form of deviation or non-compliance from the prescribed regimen results in alerting the user, a care giver, a family member, a call center, a pharmacy, or a doctor. An individual at a staffed call center or a third-party central monitoring system can then take appropriate action to remedy the missteps and mitigate adverse outcome from medication non-adherence.

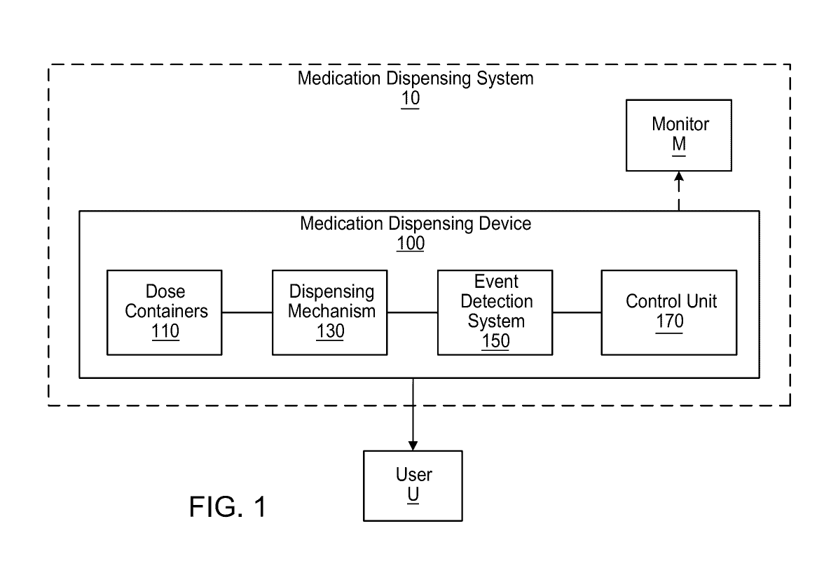

FIG. 1 is a schematic block diagram of a medication dispensing system 10 that includes a medication dispensing device 100. The medication dispensing device 100 includes medication dose containers 110, a dispensing mechanism 130, an event detection system 150, and a control unit 170. The medication dispensing device 100 can include medication to be taken by a user U (e.g., a patient, a clinical trial subject, etc.). The event detection system 150 can include a network of sensors that monitor the operations of the medication dispensing device 100. The control unit 170 can be configured to communicate information to the user U, and/or can be configured to communicate with a monitor M (e.g., an on-site computer, a remote server, a smart phone, a family member, a care giver, a call center, a pharmacy, and/or a doctor). In some embodiments, the control unit 170 can be configured to operate the dispensing mechanism 130. In some embodiments, the control unit 170 can be configured to interface with the event detection system 150 to acquire data from the network of sensors. In some embodiments, the control unit 170 can be configured to allow the sending of one-way communication to the user U and/or the monitor M. In some embodiments, the control unit 170 can be configured to allow two-way communications between the medication dispensing device 100 and the user U, between the medication dispensing device 100 and the monitor M, and/or between the user U and the monitor M. As used herein, the term “medication” can include medication in any form such as, for example, pills, parenterals, salves, creams, powders, ointments, capsules, injectable medications, drops, vitamins, suppositories, etc.

The medication dispensing device 100 can be configured to dispense the dose containers 110. The medication dose containers 110 can include any receptacle suitable for housing or containing medication. For example, each of the plurality of dose containers can define an interior region configured to contain a single medication or a plurality of medications. In some embodiments, the dose containers can be transported and/or temporarily stored in a medication cartridge or basket (not shown) (e.g. tray, sleeve, box, chamber or any shape or form of packaging enclosure or assembly). In some embodiments, the dose containers can be individually mountable on, attachable to or removable from the medication dispensing device 100 and/or a medication cartridge or basket. All, a sub-set, some or none of the dose containers can be mountable on, attachable to or removable from the medication dispensing device 100. After removal, the dose containers can be disposed of.

In some embodiments, the dose containers 110 can be custom manufactured cups. The dose containers can have rounded edges to prevent medication from sticking to the sides and/or bottom of the cup and allow easy removal of medication by the user U. One or more sides of the dose containers 110 can be rounded to allow medications to be easily poured into the hand or individually removed. In some embodiments, the dose containers 110 can include lids that can be peeled off in order for the user to access the contents of the dose containers 110. In some embodiments, the dose containers 110 can be formed from a material that is lightweight and rigid such as, for example, plastics. In some embodiments, the dose containers 110 can include at least one transparent portion, for example, a transparent base, such that the contents of the interior region of each dose container 110 can be viewed from outside of each dose container 110.

In some embodiments, the dose containers 110 can be configured to hold a plurality of the same medication, for example, three 200 mg tablets for a 600 mg dose, or a combination of various medications, for example, a diabetes managing tablet, a cholesterol reducing tablet, an arthritis capsule, a blood pressure soft gel and/or other medication as prescribed. In some embodiments, the dose containers 110 can be approximately 1½ inches in diameter and can hold up to 20 individual medications. In other embodiments, where the medication is too large to fit into a dose container 110, for example, an inhaler, a parenteral, an injectable, a patch and/or a “lollipop” like medication stick, a medication reminder marker can be placed in the dose container 110 in lieu of the medication. The medication reminder marker can be a label, a coin shaped plastic chip, and/or a paper slip. In some embodiments, the medication reminder marker can have a color and label that matches the color or label on a prescribed medication.

In some embodiments, the dose containers 110 and/or the medication cartridge, basket, tray, or sleeve, etc. can have unique identifiers, for example, labels, tags or unique shapes to correspond to at least one day of the week. In other embodiments, the dose containers 110 can have covers that can include unique identifiers such as, for example, labels or tags to indicate the day of the week on which the medication is to be taken. For example, each dose container 110 can have a barcode (not shown) printed on a surface of the dose container 110. The barcode can contain information such as the intended date and time the medication is supposed to be dispensed from the dispensing mechanism 130. In some embodiments, the barcode can also convey how many dose containers 110 remain in the medication dispensing device 100 and when more dose containers 110 need to be ordered. For example, if the dose container 110 is the only remaining dose container 110 loaded into the medication dispensing device 100, the barcode on the dose container 110 can indicate this. In some embodiments, the event detection system 150 includes a barcode sensor that is configured to read the barcodes on the dose containers 110 and transmit the information to the control unit 170.

The barcodes on the dose containers 110 can be configured to indicate that a prescription refill is necessary when there is a particular number of dose containers 110 remaining in the medication dispensing device 100. For example, the barcode on the dose containers 110 can indicate that a prescription refill is necessary four days before the medication dispensing device 100 is empty. Additionally, the barcodes on the dose containers 110 can be configured to indicate that a cartridge or basket reload is necessary when there is a particular number of dose containers 110 remaining in the medication dispensing device 100. For example, the barcode on the dose containers can indicate to the user that new dose containers 110 or a new cartridge or basket of dose containers 110 needs to be installed twenty-four hours before the medication dispensing device 100 is empty.

The control unit 170 is configured to communicate data such as, for example, the occurrence of an event, a dose container 110 removal inside the dispensing chamber, and/or other information from the medication dispensing device 100 to the user U, from the medication dose containers 110 to the monitor M, or two-way communication between the user U and the monitor M. The control unit 170 is configured to transmit data to the monitor M including a medication dispensing device or a patient identifier. In some embodiments, the control unit 170 can include speakers, a microphone, a keyboard, a display (e.g., LCD, touch screen, etc) and/or a vibrating mechanism for tactile alerts. In some embodiments, the control unit 170 can include conventional electronics for data communication and can use a standard protocol, for example, Wi-Fi, Bluetooth®, low powered Bluetooth®, Zigbee®, USB, RJ45 connection via DSL, a hardwired telephone line for connection and data communication and/or any commercially available wireless cellular networks such as, Global System for Mobile Communications (GSM), Code Division Multiple Access (CDMA) or Long-Term Evolution (LTE). In some embodiments, the control unit 170 can also include data storage capabilities, for example, to store event data, including step by step or chronological operation log, patient prescription information and/or other patient health monitoring data.

In some embodiments, the control unit 170 can also include a computing module that includes a processor and memory configured to process input information and/or execute computer algorithms. In some embodiments, the control unit 170 can also include a notification system configured to provide audio, visual, and/or tactile alerts to a patient or communicate with patient as described in detail below. In some embodiments, the control unit 170 can be integrated into the medication dispensing device 100. In some embodiments, the control unit 170 can be a separate device, for example, a smart phone (Android, iPhone), a tablet, a local computer a remote computer, and/or server, etc., that can communicate with the medication dispensing device 100 via a network, which may be any type of network (e.g., a local area network or LAN, a wide area network or WAN, a virtual network, a telecommunications network, and/or the internet) implemented as a wired network and/or a wireless network. Any or all communications may be secured (e.g., encrypted) or unsecured.

In some embodiments, the control unit 170 can be activated on demand, for example, by the user U through a communication interface (not shown) or remotely by an automated system, for example, by a smart phone application and/or the monitor M. In some embodiments, the control unit 170 can be configured to periodically reestablish connection with the monitor M for real-time monitoring of the medication dispensing device 100. The medication dispensing device 100 can be configured to send confirmation to the monitor M that the machine is functioning at regular predetermined intervals. This can be useful, for example, in an event where the medication dispensing device 100 is unplugged or loses power.

In some embodiments, the control unit 170 can be configured to receive home health monitored data such as, for example, weight, blood pressure, EKG, oxygen saturation, actigraphy, measures of exercise (e.g., steps taken), pulmonary function, water retention, blood glucose, temperature and/or other medically relevant information that can be collected at the user's U home. The user U can enter this data manually into the control unit 170 through the communication interface, through a voice recognition capability of the control unit 170, or the control unit 170 can be configured to wirelessly interface and collect information from other home health monitoring devices/equipment. In some embodiments, the health monitoring data can be correlated with the dose compliance data collected by the medication dispensing device 100. This combined/correlated data can be used to determine the efficacy of the prescribed drug regimen, side effects, changes to prescribed dosage and/or overall patient health progression.

As described herein, the control unit 170 can include a notification system configured to provide an alert to the user U when it is time for the patient to take a prescribed medication. The user U can be the patient or a caregiver. In some embodiments, the notification system can be configured to display a message such as, for example, “It's time for your evening dose Mr. Jones.” In some embodiments, the notification system can be configured to produce an audible message and/or a signal such as, for example, a beep or alarm. In some embodiments, the notification system can be configured to produce a visual message and/or a signal such as, for example, a blinking or flashing LED light. In some embodiments, the notification system can be configured to provide a reinforcement message (audible or visual) such as, for example, “well done Mr. Jones” if the dose container 110 is removed from a dispensing chamber of the medication dispensing device 100 at the prescribed time.

In some embodiments, the medication dispensing device 100 can be configured to play music to indicate the status of the medication dispensing device 100 to the user and prompt the user to complete an action. For example, the medication dispensing device 100 can be configured to play three songs. The first song can be played while the dose container 110 is prepared to be removed by the user U. The second song can be played once the dose container 110 is ready to be removed by the user U until the user U removes the dose container 110. The third song can be played until the user U closes a door on the medication dispensing device 100.

In some embodiments, the control unit 170 can be configured to provide reminders and/or warnings if a dose container 110 is not removed at the prescribed time or if the number of dose container accessed is not as prescribed. For example, the control unit 170 can be configured to communicate an escalating audible, visual or tactile signal to the user U after predetermined time thresholds to remind the user U to take their medication. In some embodiments, the medication dispensing device 100 can include an LED light (not shown) that illuminates when a dose container 110 is ready to be removed. The LED light can remain illuminated until the dose container 110 is removed. After a predetermined time has elapsed and/or a predetermined number of reminders have been communicated to the user U without the correct medication being taken, the control unit 170 can be configured to communicate an alert to the monitor M. Additionally, the control unit 170 can be configured to prevent the medication dispensing device 100 from dispensing a dose container if a predetermined length of time has elapsed since the missed dose. The medication dispensing device 100 can be configured to include an override feature to retrieve the dose. The override feature can be utilized through special actions and/or support center guidance. The override feature can be manual (e.g. a two-button unlocking maneuver) or electronic (e.g. a passcode previously created by the user U or communicated by the monitor M).

In some embodiments, the control unit 170 can be configured to recognize an erroneous event, for example, a wrong number of dose container 110 being removed, and communicate an audible, visual or tactile signal to the user U. If no remedial action is taken after a predetermined period of time, the control unit 170 can be configured to communicate an alert to the monitor M. In some embodiments, the control unit 170 can be configured to detect a critical event, for example, too many dose containers 110 being removed, and communicate an alert to the user U, and at the same time or after a predetermined time, to communication a time-stamped alert to the monitor M and/or emergency personnel (e.g., call 911). In some embodiments, the control unit 170 can be configured to automatically call the patient's pharmacy when it is time for a refill. The control unit 170 can also be configured to communicate a time-stamped alert in the event of an empty machine or other atypical events.

In some embodiments, the notification system can be configurable by the user U. For example, the user U can use the control unit 170 interface (e.g., keyboard, touch screen, etc.) to input preferences such as alarm tones, clock time, activate/deactivate alarms (with permission from monitor M), view dosage information, set alarms, lighting preferences, display messages, voice, sound, email/message preferences, and/or message frequency. Furthermore, the user U can also deactivate the notification system, for example, if the patient is travelling, hospitalized, sleeping, or discontinues use for an extended period of time. In other embodiments, the notification system is preset based on prescription data. In some embodiments, the notification system can be configured to notify other scheduled activities of the user U, e.g., health reminders such as “check your weight”, “check your blood pressure”, “time to refill your prescription” and/or social reminders such as “today is bingo day”. In some embodiments, a doctor can communicate information through a telemedicine visit to the user U through the control unit 170 to advise user U of any changes to their treatment regimen.

In some embodiments, the control unit 170 can include voice recognition (VR) capabilities for receiving prescription updates from an authorized medication prescriber, e.g., doctor, and automatically update the user's prescription regimen in the medication dispensing device 100. For example, the patient can take the medication dispensing device 110 or a removable control unit 170 (e.g., smart phone) to a doctor appointment where the control unit 170 can read and/or display the current user's prescription to the doctor. The doctor can use the voice recognition capability of the control unit 170 to record the updated medication regimen to the medication dispensing device 100. In some embodiments, the vocabulary allowed for recording deletion can be highly limited, for example, less than 10 items. In some embodiments, the vocabulary allowed for addition of medications can be less restrictive, for example, a vocabulary of less than 1,500 items. The syntax of prescribing can be fixed and rigid, e.g. “Clonazepam 1 mg po every 12 hours”. The voice recognition can be capable of capturing dosing even if titration is involved, e.g., “Clonazepam 1 mg po every 12 hours for 5 days; then clonazepam 0.5 mg po every 12 hours.” The updated prescription medication list can also be communicated to the monitor M, to all authorized physicians, and/or to authorized medication dispensers, e.g. pharmacy, doctor, clinical trial manager. Any adverse effects or interactions can therefore be identified in a timely manner and rectified.

The monitor M can monitor and ensure patient adherence to the prescribed treatment and/or prescription regimen. In some embodiments, the monitor M can be integrated with the medication dispensing device 100. For example, the computing module of the control unit 170 can be configured to serve as the monitor M as described above and no external monitoring is performed. In some embodiments, the monitor M can be an external entity, for example, a family member, a care giver, a nurse, a pharmacy, a doctor, a clinical trial manager, and/or a call center. In some embodiments, the monitor M can be a computer configured to automatically monitor patient adherence to a treatment regimen. For example, if the user U removes the prescribed dosage from the medication dispensing device 100 at the correct time, the event detection system 150 can record an event. The control unit 170 can further communicate data of the event to the monitor M, where data is time stamped and recorded but no action is taken. If the user U fails to take prescribed dosage even after the time threshold set for audible or visual notifications on the notification system, the control unit 170 can convey an alert to the monitor M. The monitor M can then contact the user U, e.g., via email, text message, phone call, audio/visual interface of the notification system, and/or personal visit to correct the action. The same protocol can be followed in case of an event where an incorrect dose container or a plurality of dose containers 110 are removed or attempted to be removed. In case of a critical event, for example, a user U attempts to activate the dispensing mechanism when it is not an appropriate dosing time, an immediate alert can be sent to the user U and the monitor M. The monitor M can respond by contacting the user U, e.g. by audio/visual/tactile notification on the medication dispensing device 100, phone call, text message, and/or personal visit, and if no response is received, call the emergency personnel.

In some embodiments, the monitor M can ensure that the medication dispensing device 100 is accurately filled with medication. For example, the dose containers 110 and/or the medication cartridge or basket that contains a plurality of dose containers 110 can be securely inserted inside the medication dispensing device 100 by the monitor M. In some embodiments, the event detection system 150 can detect the event of proper and accurate loading of the medication dose containers 110 and/or medication cartridge or basket into the medication dispensing device 100. For example, the event detection system 150 can operate the barcode scanner to confirm that the correct dose container 110 is ready to be dispensed. If the correct dose containers 110 were loaded within the medication dispensing device 100, the event detection system 150 will maintain time stamped records of such events. In such case, the event detection system 150 can send a time-stamped communication to the control unit 170 to notify the monitor M that such an event has occurred as described herein. If an inaccuracy is determined, the monitor M can alert the patient, a care giver, a family member, a pharmacy, a doctor, a clinical care team, and/or a clinical trial manager. Once the inaccuracy is rectified and the proper dose containers 110 is loaded in the medication dispensing device, the method can be repeated again to confirm the proper and accurate loading of the dose containers 110.

In further embodiments, the monitor M can also prevent deviations from a treatment regimen. For example, at the prescribed time, the user U can access the dose container 110 to extract medication. The event detection system 150 can record an event and the status of such event can be communicated to the control unit 170 and/or monitor M. If the correct dose was removed, the data can be time stamped, stored and no further action is taken. Alternatively, the control unit 170 can send a time-stamped confirmation of dose removal can be transmitted to the monitor M. If there is a deviation in dose removal, for example, if the user U was prescribed 600 mg of a medication that corresponds to 2 dose containers 110 but only 300 mg of the medication (1 dose container 110) was withdrawn from the dispensing chamber of the medication dispensing device 100, the control unit 170 can send a time-stamped alert of late, missed, or otherwise incorrectly removed dosage to the monitor M. The monitor M can then send an alert and notify of the deviation to the user U. If the deviation is not corrected, further alerts can be sent to a care giver, a loved one, a doctor, and/or a clinical trial manager.

In some embodiments, the medication dispensing device 100 can be configured so that more than one dose container 110 can be dispensed from the medication dispensing device 100 in a single operation. This could be useful for, for example, weekend trips away from the medication dispensing device 100. The barcode scanner is configured to scan each dose container 110 before each dose container 110 is dispensed from the medication dispensing device 100.

In some embodiments, the medication dispensing device 100 can be configured so that the dose containers 110 are removable from the medication dispensing device 100 without being dispensed by the dispensing mechanism 130. For example, if a patient's doctor decides to change the patient's treatment regimen partially through a cartridge or basket of dose containers 110, the user U can remove the loaded dose containers 110 and replace them with new dose containers 110. In some embodiments, the medication dispensing device 100 can include a loading door (not shown) for loading of the dose containers 110 and a removal door (not shown) for removal of the dose containers 110.

In some embodiments, the medication dispensing device 100 can be powered by a line transformer (not shown) that provides low voltage DC throughout the medication dispensing device 100. Additionally, the medication dispensing device 100 can includes a backup battery (not shown) that will provide full operational functionality in the event of power loss. For example, the backup battery can provide enough power to support the operational functionality of the machine for at least four hours. The medication dispensing device 100 can be configured to store and transmit a time-stamped alert to the monitor M that the medication dispensing device 100 is running on the backup battery. Additionally, when connected to a commercially available wireless cellular network, the commercially available wireless cellular network can provide date and time clock information to the medication dispensing device 100 in order to refresh and calibrate a clock of the backup battery.

Having described above various general principles, several exemplary embodiments of these concepts are now described. These embodiments are only examples, and many other configurations of a medication dispensing device 100, system 10 and/or methods for monitoring and ensuring patients adherence to a prescribed medication regimen, are contemplated.

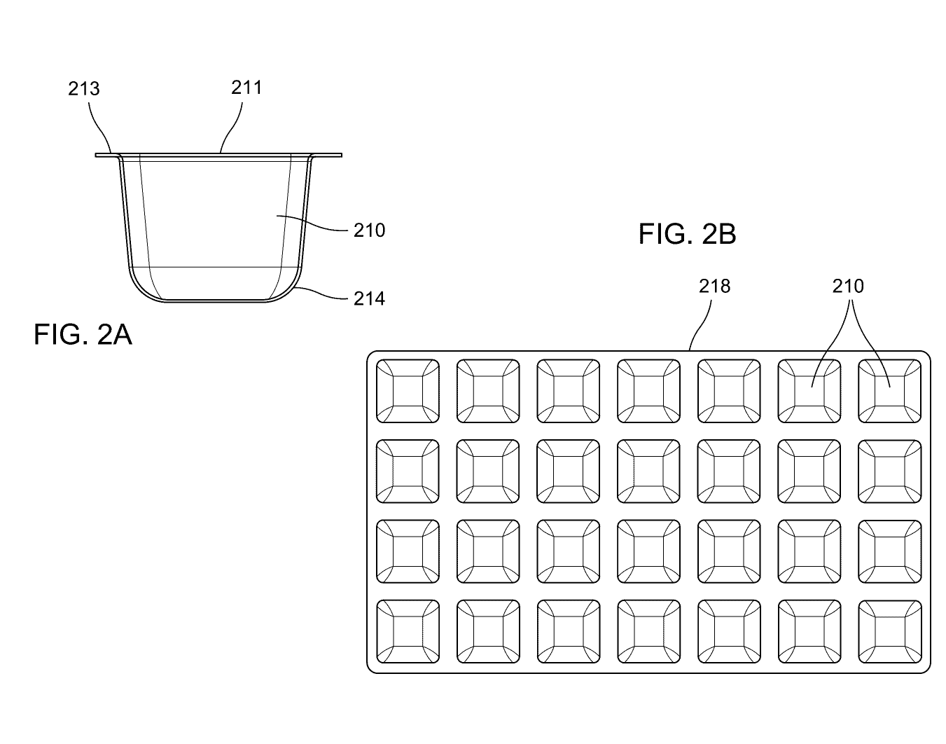

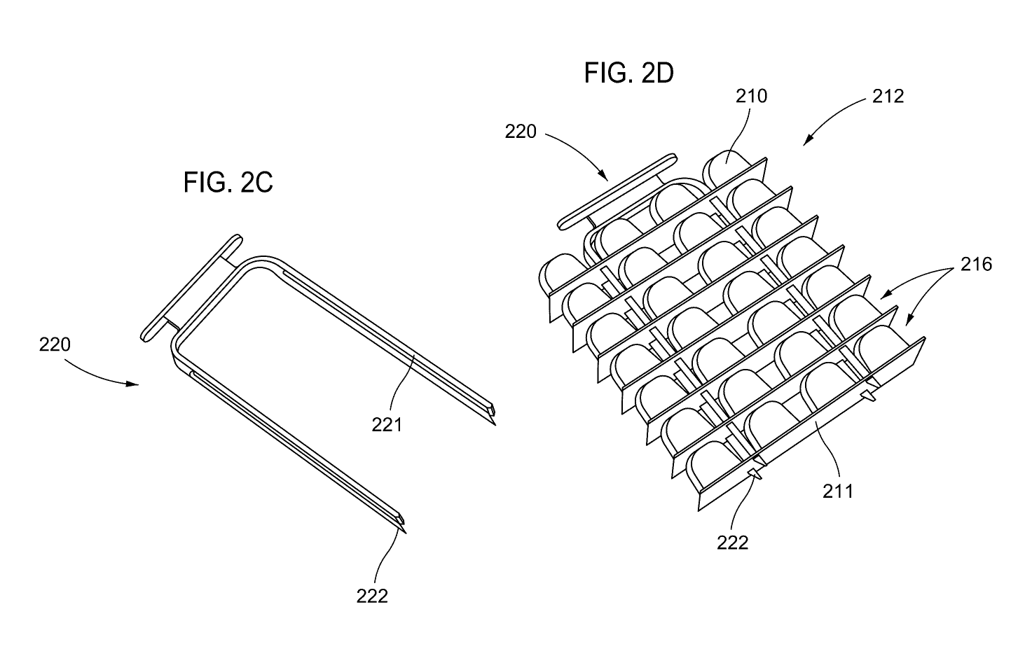

FIG. 2A is side view of a dose container 210 according to an embodiment of the present disclosure. The dose container 210 defines an interior region configured to contain a single medication or a plurality of medications. The dose container 210 can be shaped as a plastic cup with rounded edges 214 to prevent medication from sticking to the sides and/or bottom of the cup and allow easy removal of medication by the user. One or more sides of the dose container 210 can be rounded to allow medications to be easily poured into the hand or individually removed. In some embodiments, the dose containers 210 can include lids that can be peeled off in order for the user to access the contents of the dose containers 210. In some embodiments, the dose container 210 can be formed from a material that is lightweight and rigid such as, for example, plastics. In some embodiments, the dose container 210 can include at least one transparent portion, for example, a transparent base, such that the contents of the interior region of the dose container 210 can be viewed from outside of the dose container 210.

The dose container 210 can have unique identifiers, for example, labels, tags or unique shapes to correspond to at least one day of the week. In other embodiments, the dose containers 210 can have covers that can include unique identifiers such as, for example, labels or tags to indicate the day of the week on which the medication is to be taken. For example, the dose container 210 can have a barcode (not shown) printed on a bottom surface 211 of the dose container 210. The barcode can contain information related to the dispensing of the dose container 210, as described above with reference to dose container 110.

FIG. 2B is a top view of a tray 218 forming an array of dose containers 210 according to an embodiment of the present disclosure. In some embodiments, an array of dose containers 210 can be formed as a unitary tray 218. The tray 218 can be filled with medication at a pharmacy according to a user's treatment regimen. In some embodiments, loading the dose containers at a pharmacy and verifying the medication prior to shipment can eliminate loading errors that can occur when pill containers are filled by the patent, family, visiting nurses, etc., which typically go undetected. The tray 218 can then be sealed and the dose containers 210 can be labeled with individual barcodes. The tray 218 can then be separated into strips 216 (shown in FIG. 2D) for loading into a medication dispensing device (not shown).

FIG. 2C is an illustration of a quill 220 for use in a cartridge according to an embodiment. The quill 220 includes arms 221 and sharpened tips 222. The sharpened tips 222 are configured to pass through openings (now shown) in the strips 216 so that the strips 216 are arranged on the arms 221 of the quill 220. The sharpened tips 222 can include an enlarged diameter relative to the arms 221 so that the strips 216 can be secured on the arm. The tips 222 can also include a starburst design to facilitate their passage through the flanges 213 of the bottom surfaces 211 of the strips 216.

FIG. 2D is a perspective view of a cartridge 212 according to an embodiment of the present disclosure. The cartridge 212 includes vertically-stacked strips 216. The strips 216 are secured together by the quill 220. In an assembled configuration, the cartridge 212 can be transported to the user and the user can load the cartridge 212 into a medication dispensing device. Additionally, a number of the flanges 213 of the bottom surfaces 211 of the strips 216 can include precut openings so that the tips 222 can easily pass through all but the bottommost strip 216. The precut openings can be die cut.

Although the strips 216 are shown as including four dose containers 210, the strips 216 can include any number of dose containers 210 that is appropriate for a particular user's treatment regime. Although the cartridge 212 is shown as including seven strips 216, the cartridge 212 can include any number of dose containers 210 that is appropriate for a particular user's treatment regime. For example, the dose containers 210 can be arranged in a “number of doses per day” by “day of the week” (e.g., N×7) array, with each dosage in an individual dose container. Said another way, the dose containers 110 can be arranged to have dose containers, for example, in a 2 dose/day×7 days, 3 dose/day×7 days, or 4 dose/day×7 days dosing regimen.

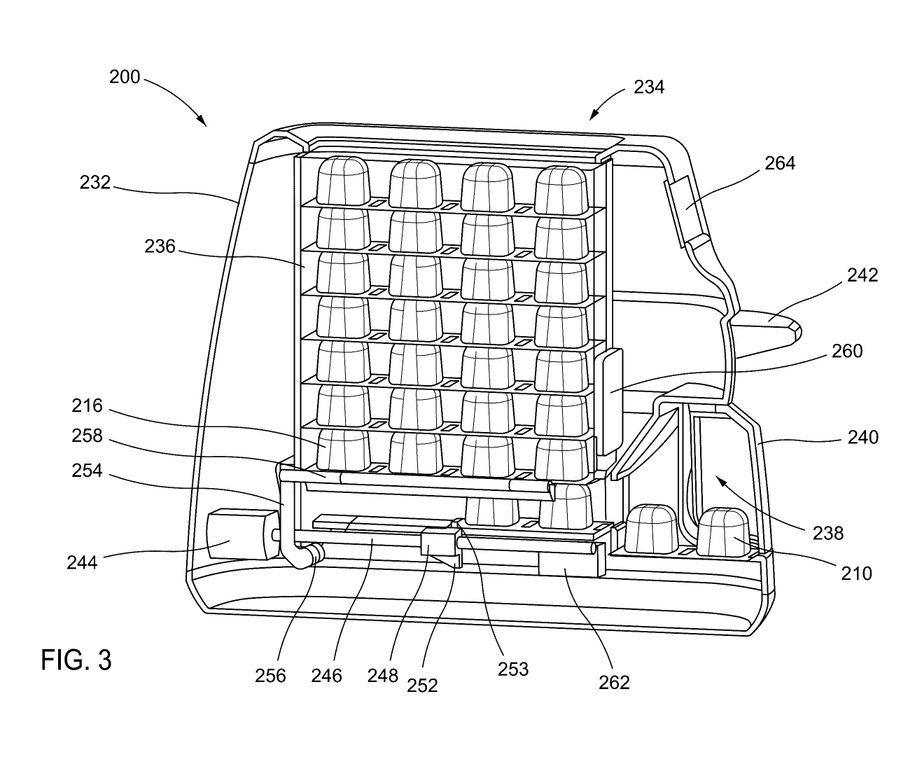

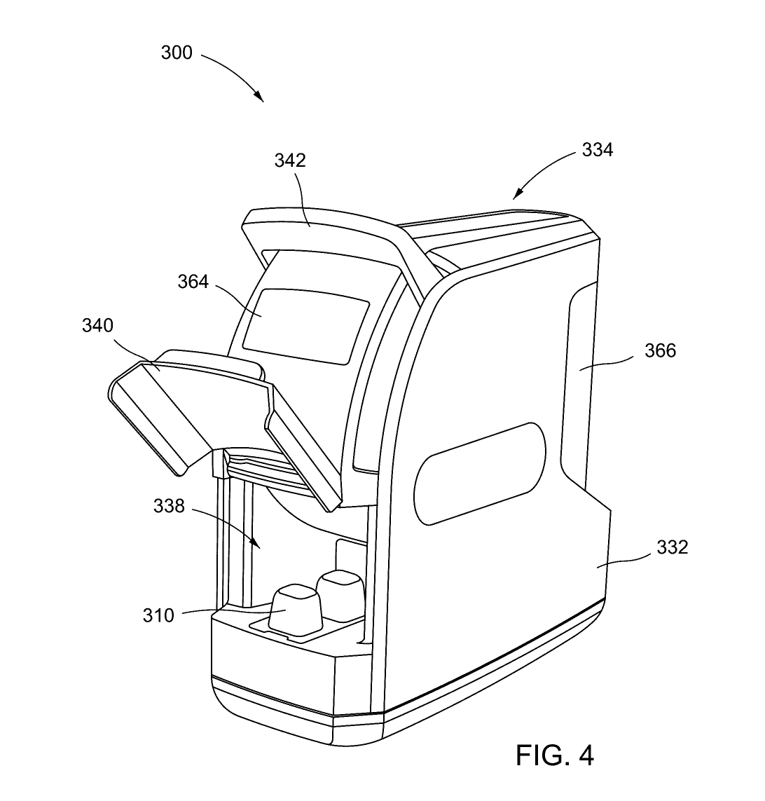

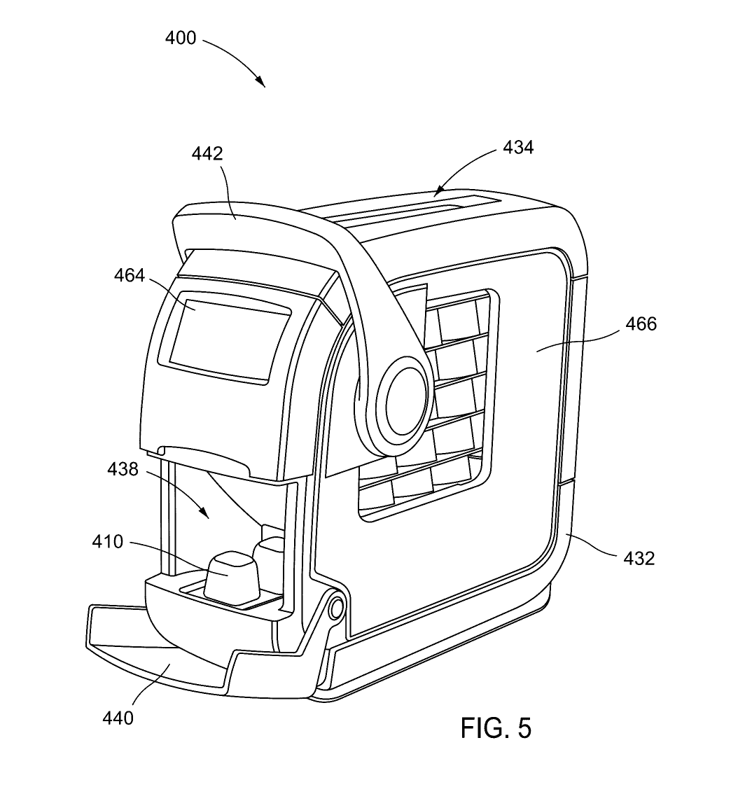

FIG. 3 is a cross-sectional view of a medication dispensing device 200 according to an embodiment of the present disclosure. The medication dispensing device 200 includes a housing 232 and a sleeve 236. The housing 232 includes a cartridge opening 234 for insertion of the cartridge 212 into the sleeve 236. The housing 232 can include a retention feature (not shown), such as spring-loaded pawls, in order to prevent the pill strips 216 from being pulled back out once inserted into the sleeve 236. In some embodiments, the medication dispensing device 200 can include a loading door (not shown) to block the cartridge opening 234. The loading door can include a lock so that the loading door can only be opened through special actions and/or approval communicated to a control unit by a monitor.

To load the pill strips 216 into the sleeve 236, the pill cartridge 212 is inserted into the sleeve 236. In order to ensure the cartridge 212 is inserted in the correct orientation, the cartridge 212 is structured so that it can only be inserted into the sleeve 236 and/or the cartridge opening 234 in one orientation. Once the cartridge 212 has been inserted into the sleeve 236, the quill 220 can be withdrawn from the sleeve 236. The retention feature prevents the strips 216 from being withdrawn from the sleeve 236. As a result, the quill 220 can be withdrawn from the strips 216, leaving the strips 216 within the sleeve and ready to be dispensed to the user.

The housing 232 also includes an antechamber 238 which is enclosed by a door 240. The medication dispensing device 200 is configured to dispense dose containers 210 into the antechamber 238. The user can open the door 240 to access any dose containers 210 within the antechamber 238. Additionally, the door 240 can be secured in a closed position by a locking assembly (not shown). The locking assembly may be a magnet assembly that is controlled by a control unit (not shown). The control unit can be configured to control the locking assembly to prevent a user from accessing the antechamber 238 except at appropriate dosing times. Additionally, the antechamber 238 can include an LED light (not shown) that illuminates when a dose container 210 is ready to be removed. The LED light can remain illuminated until the dose container 210 is removed.

In some embodiments, the antechamber 238 can include a trap door (not shown). The medication dispensing device 200 can be configured so that if the dose container 210 is not removed within a predetermined time period, the trap door can open and cause the dose container 210 in the antechamber 238 to fall into a receptacle (not shown) below the antechamber 238. As a result, a patient can be prevented from taking the dose outside of the appropriate timeframe. Additionally, if a dose is missed, the missed dose container 210 will not obstruct the delivery of the next dose container 210. The medication dispensing device 200 can include a manual override procedure and associated components in order to remove the missed dose container 210 from the receptacle below the antechamber 238.

The medication dispensing device 200 includes an indexing assembly for moving the dose containers 210 into the antechamber 238. The indexing assembly includes a drive motor 244, a lead screw 246, and a drive block 248. The drive motor 244 is configured to rotate the lead screw 246 in order to move the drive block 248 along the lead screw 246. As the drive block 248 is moved along the lead screw 246 toward the antechamber 238, a protrusion 253 on the drive block 248 pushes the bottommost strip 216 toward the antechamber 238.

The medication dispensing device 200 can include a barcode scanner 262 and/or any other type of scanning system (e.g., QR code, RFID, etc.). When a dose container 210 is located near the barcode scanner 262, the barcode scanner 262 is configured to read information on the label of the dose container 210. The barcode scanner 262 is configured to communicate with a control unit (not shown). As described above with reference to the dispensing device 100 of FIG. 1, if the control unit determines that it is the appropriate time to dispense the particular dose container 210, then the control unit can initiate operation of the indexing assembly.

The medication dispensing device 200 can include a blade assembly (also referred to herein as a “cutting assembly”). The blade assembly includes a blade motor (not shown) and a blade 260. When the indexing assembly has pushed a strip 216 so that a dose container 210 extends past the edge of the sleeve 236 into the antechamber 238, the control unit can be configured to actuate the blade motor to move the blade 260 into cutting contact with the strip 216 to separate the dose container 210 in the antechamber from the remaining dose containers 210 on the strip 216. After cutting the strip 216, the blade motor is configured to retract the blade 260 so that it is not accessible by the user via the antechamber 238. The dose container 210 that was separated from the pill strip 216 is able to be removed from the antechamber 238 by the user.

After the final dose container 210 in a pill strip 216 is pushed into the antechamber 238, the drive motor 244 is configured to reverse direction and rotate the lead screw 246 so that the drive block 248 is moved toward its home position near the drive motor. When the drive block 248 reaches its home position, a ramp 252 on the drive block 248 is configured to contact a bearing 256 on a slide 254. The slide 254 is connected to a drop mechanism 258. When the ramp 252 moves proximally relative to the bearing 256, the ramp 252 is configured to push the bearing 256 downward, causing the slide 254 to move downward. The downward movement of the slide 254 causes the drop mechanism 258 to rotate away from the sleeve 236 and out of a blocking position. This allows the remaining pill strips 216 in the sleeve 236 to fall downward. The bottommost pill strip 216 will drop into the area below the drop mechanism 258, ready to be indexed into the antechamber 238. At the appropriate time, the control unit will cause the drive motor 244 to rotate the lead screw 246 and move the drive block 248 away from the home position. As the drive block 248 begins to move the bottommost pill strip 216 toward the antechamber 238, the ramp 252 will move out of contact with the bearing 256, causing the drop mechanism 258 to move back into its blocking position. Once in its blocking position, the drop mechanism will prevent the next highest pill strip 216 from falling to the bottom of the sleeve 236.

Additionally, in some embodiments, the medication dispensing device 200 can be configured so that the dose containers 210 are removable from the medication dispensing device 200 without being dispensed by the indexing assembly. For example, if a patient's doctor decides to change the patient's treatment regimen partially through a cartridge 212 of dose containers 210, the user can remove the loaded dose containers 210 and replace them with new dose containers 210. In some embodiments, the medication dispensing device 200 can include a removal door (not shown) on the back of the housing 232 for removal of the dose containers 210. In some embodiments, the sleeve 236 containing the loaded dose containers 210 can be removable from the medication dispensing device 200 through the removal door or through the opening 234. The removal door can include a lock so that the removal door can only be opened through special actions and/or approval communicated by a monitor. In some embodiments, the lock on the removal door can be controlled by the control unit.

The operation of the medication dispensing device 200, beginning with the indexing operation, can be actuated by movement of a paddle lever 242. Alternatively, the medication dispensing device 200 can be configured to automatically perform the indexing operation at the appropriate time for a dose to be taken. After the indexing assembly has moved a dose container 210 into the antechamber 238, the user can move the paddle lever 242 to initiate a cutting operation to separate the dose container 210 in the antechamber 238 from the remaining dose containers 210 on a strip 216. Although shown as actuated by the lever 242, the indexing and/or cutting operations of the medication dispensing device 200 can alternatively be actuated by a button, or a lever that functions as a button. The lever 242 can be configured to activate the operation of the blade motor of the blade assembly. Alternatively, the lever 242 can be configured to mechanically operate the blade 260 in order to perform the cutting operation without electrical components.

The medication dispensing device 200 includes an electronic display 264. The display 264 is configured to communicate information to the user. The display 264 can have variable font size, which can be set by the user. The display 264 can display the date, time, error messages, dose reminders, missed dose warnings, operating instructions, and other information. The display 264 can display black text on a white background, or any other color combination. The display 264 can be operatively connected with a knob or button to adjust the brightness of the display 264. Alternatively or additionally, the display can include touch screen controls to control the brightness of the display 264.

The medication dispensing device 200 can include an audio output (not shown). The audio output can include alarms, signal beeps and verbal communication controlled by the control unit. The audio output can include variable loudness. For example, the volume can range from 80 dB to 100 dB. The volume can be controlled by the user through an associated knob, buttons, or touch screen control. The medication dispensing device 200 can be configured to play music to indicate the status of the medication dispensing device 200 to the user and prompt the user to complete an action. For example, the medication dispensing device 200 can be configured to play three songs. The first song can be played while the indexing assembly moves the dose container 210 into the antechamber. The second song can be played once the dose container 210 is ready to be removed by the user until the user removes the dose container 210. The third song can be played until the user closes the door 240.

In some embodiments, the medication dispensing device 200 can include an optical sensor (not shown) that is configured to detect whether a dose container 210 is within the antechamber 238. The control unit can be configured to communicate the presence or absence of a dose container 210 within the antechamber 238 to a monitor, as described above with reference to medication dispensing system 10.

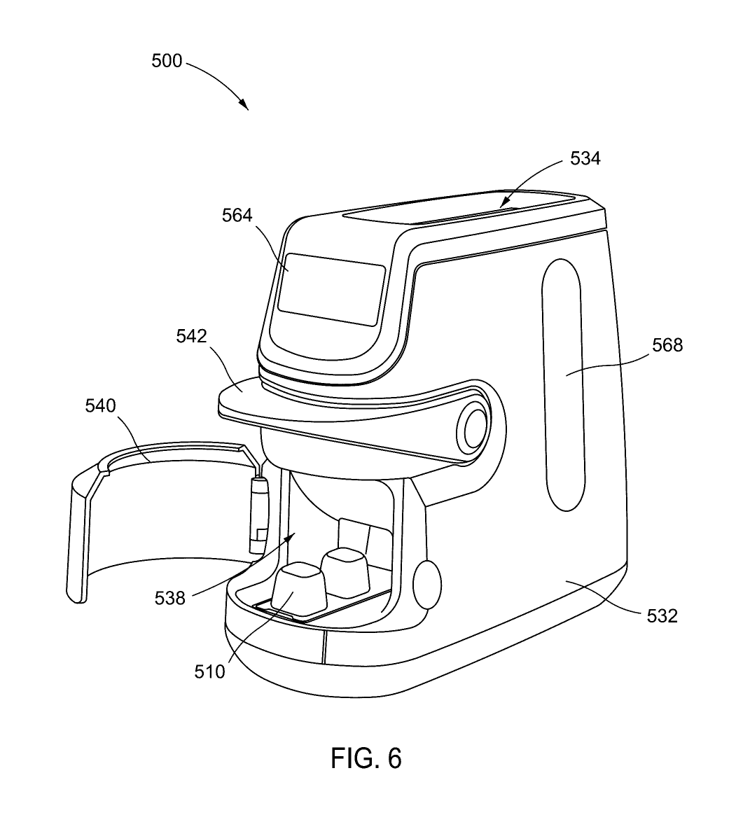

FIG. 4 is a perspective view of a medication dispensing device 300 according to an embodiment of the present disclosure. The medication dispensing device 300 includes a housing 332. The housing 332 defines a cartridge opening 334 and an antechamber 338. The antechamber 338 is enclosed by a door 340. The door 340 is configured to rotate upward to allow the user to access a dose container 310 in the antechamber 338. The medication dispensing device 300 also includes a paddle lever 342 configured to actuate a dispensing operation, such as an indexing operation, cutting operation, or door opening operation, of the medication dispensing device 300. A display 364 is located on the housing 332 of the medication dispensing device 300. The display 364 is similar to display 264 described with reference to medication dispensing device 200 above and will not be further describe here. The housing 332 also includes a translucent section 366 that allows a user to view dose containers that have been loaded into the cartridge opening 334. The medication dispensing device 300 can include the same as or similar features and/or functions as described above for medication dispensing device 100 and medication dispensing device 200, and therefore, certain features and functions will not be described in detail with respect to medication dispensing device 300.

FIG. 5 is a perspective view of a medication dispensing device 400 according to an embodiment of the present disclosure. The medication dispensing device 400 includes a housing 432. The housing 432 defines a cartridge opening 434 and an antechamber 438. The antechamber 438 is enclosed by a door 440. The door 440 is configured to rotate downward to allow the user to access a dose container 410 in the antechamber 438. The medication dispensing device 400 also includes a paddle lever 442 configured to actuate a dispensing operation, such as an indexing operation, cutting operation, or door opening operation, of the medication dispensing device 400. A display 464 is located on the housing 432 of the medication dispensing device 400. The display 464 is similar to display 264 described with reference to medication dispensing device 200 above and will not be further describe here. The housing 432 also includes a translucent section 466 that allows a user to view dose containers that have been loaded into the cartridge opening 434. The medication dispensing device 400 can include the same as or similar features and/or functions as described above for medication dispensing device 100 and medication dispensing device 200, and therefore, certain features and functions will not be described in detail with respect to medication dispensing device 400.

FIG. 6 is a perspective view of a medication dispensing device 500 according to an embodiment of the present disclosure. The medication dispensing device 500 includes a housing 532. The housing 532 defines a cartridge opening 534 and an antechamber 538. The antechamber 538 is enclosed by a door 540. The door 540 is configured to rotate outward to the side (e.g. swivel) to allow the user to access a dose container 510 in the antechamber 538. The medication dispensing device 500 also includes a paddle lever 542 configured to actuate a dispensing operation, such as an indexing operation, cutting operation, or door opening operation, of the medication dispensing device 500. A display 564 is located on the housing 532 of the medication dispensing device 500. The display 564 is similar to display 264 described with reference to medication dispensing device 200 above and will not be further describe here. The housing 532 also includes a recessed view window 568 that allows a user to view dose containers that have been loaded into the cartridge opening 534. The recessed view window 568 can include a translucent section (not shown). The medication dispensing device 500 can include the same as or similar features and/or functions as described above for medication dispensing device 100 and medication dispensing device 200, and therefore, certain features and functions will not be described in detail with respect to medication dispensing device 500.

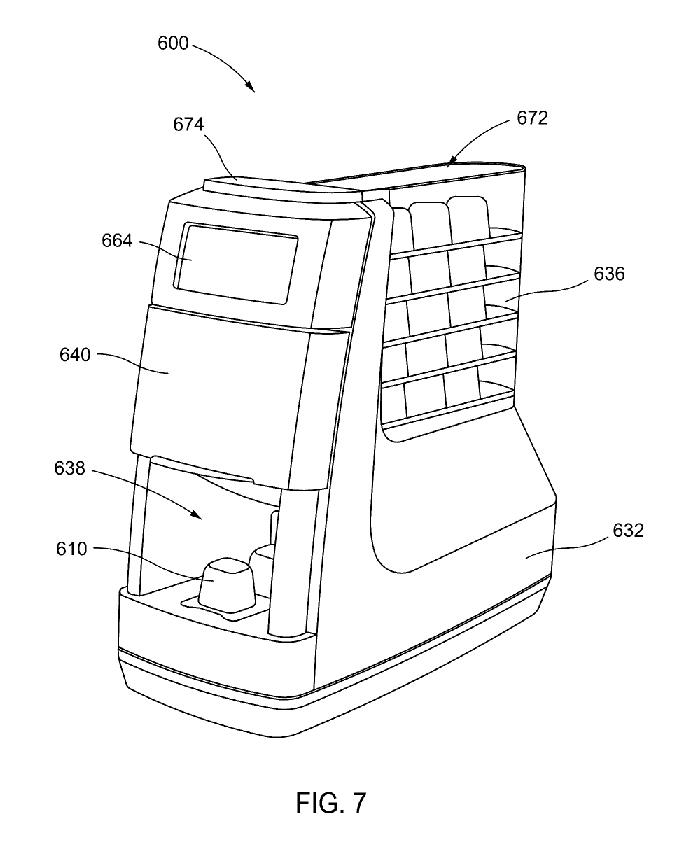

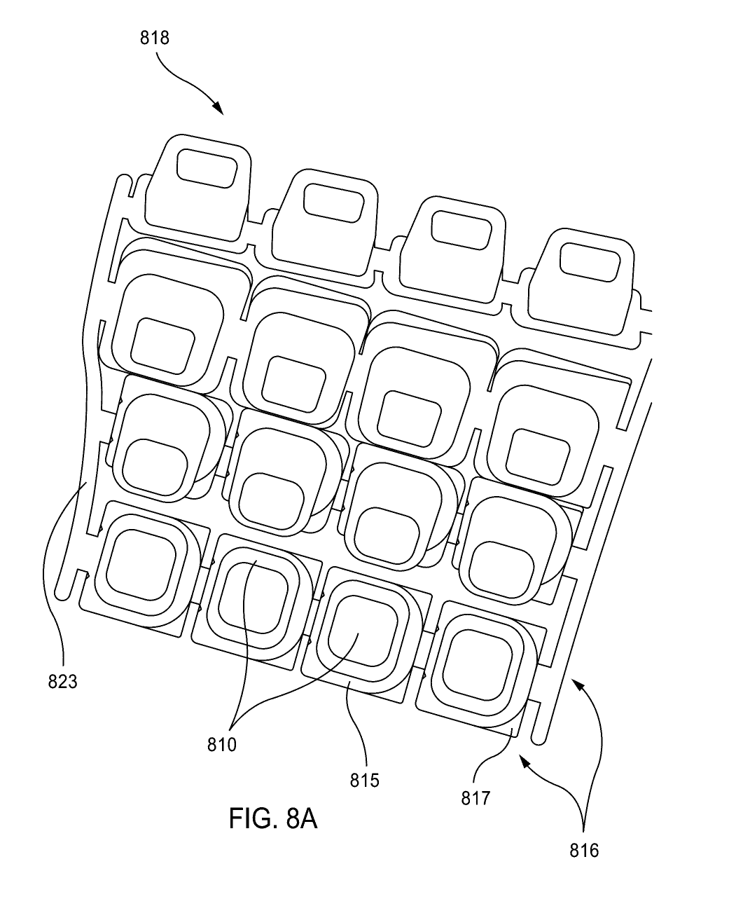

FIG. 7 is a perspective view of a medication dispensing device 600 according to an embodiment of the present disclosure. The medication dispensing device 600 includes a housing 632. The housing 632 defines an antechamber 638. The antechamber 638 is enclosed by a door 640. The door 640 is configured to slide upward to allow the user to access a dose container 610 in the antechamber 638. The medication dispensing device 600 also includes a push button 674 configured to actuate a dispensing operation, such as an indexing operation, cutting operation, or door opening operation, of the medication dispensing device 600. A display 664 is located on the housing 632 of the medication dispensing device 600. The display 664 is similar to display 264 described with reference to medication dispensing device 200 above and will not be further describe here. The housing 632 also includes a sleeve 636 configured to hold the dose containers 610 that have been loaded into the medication dispensing device 600. The sleeve 636 can be translucent so that the dose containers 610 are able to be viewed through the sleeve 636. The dose containers 610 can be loaded into the sleeve 636 through a sleeve opening 672 using a cartridge similar to pill cartridge 212 described above with reference to FIG. 2D. The medication dispensing device 600 can include the same as or similar features and/or functions as described above for medication dispensing device 100 and medication dispensing device 200, and therefore, certain features and functions will not be described in detail with respect to medication dispensing device 600.

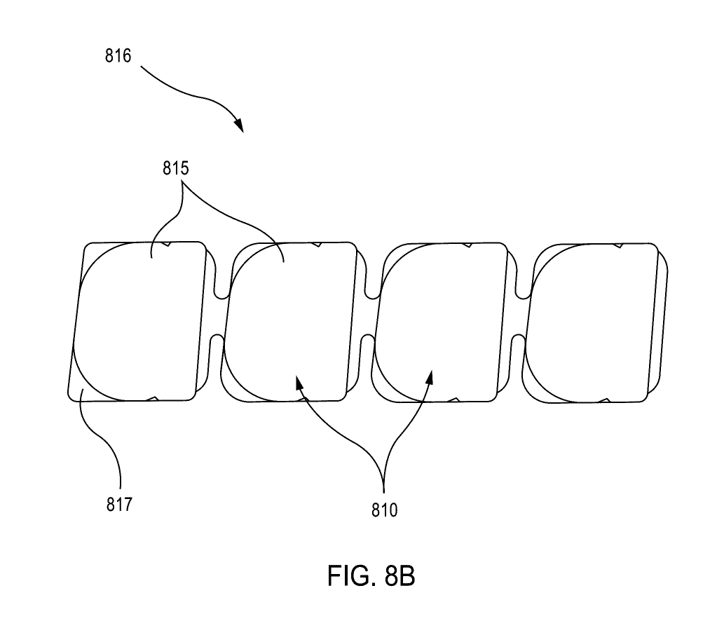

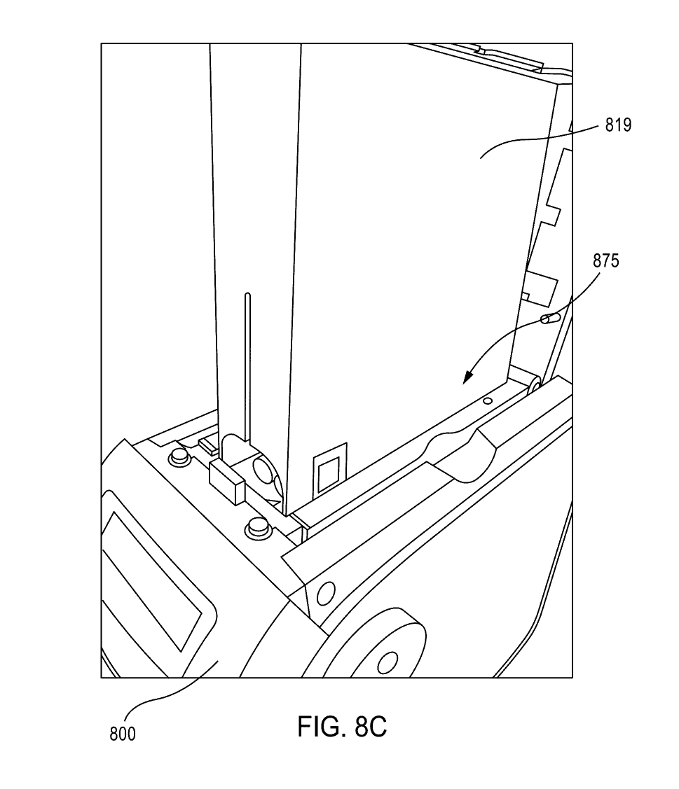

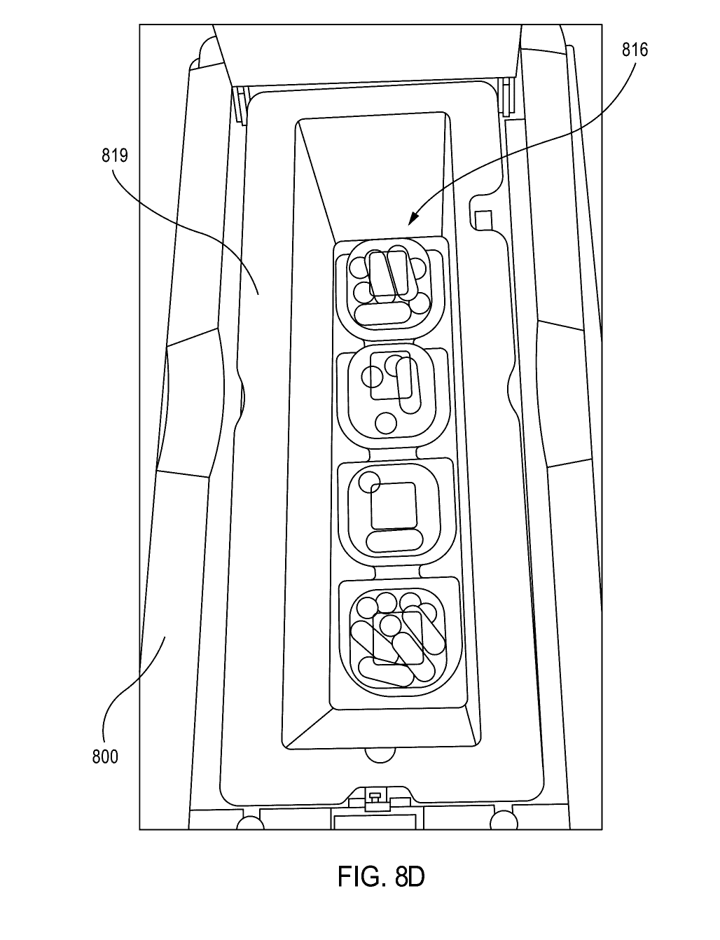

In some embodiments, a removable basket can be pre-loaded with dose containers and inserted into a medication dispensing device. For example, FIG. 8A is a perspective view of a tray 818 forming an array of dose containers 810 for use with a removable basket 819 (shown in FIGS. 8C and 8D) according to an embodiment. The tray 818 and the dose containers 810 can be the same or similar in structure and function as the tray 218 and the dose containers 210 described above with reference to FIGS. 2A-2B. For example, the tray 818 can be a unitary tray forming an array of dose containers 810. Each of the dose containers 810 can include a base 817 and a lid 815 that can be separated from (e.g., peeled off) the base 817 for access by the user to the contents of each of the dose containers 810. Each of the dose containers 810 can define an interior region (e.g. defined by the base 817 and lid 815) configured to contain a single medication or a plurality of medications. The tray 818 can be filled with medication at a pharmacy according to a user's treatment regimen. The tray 818 can be sealed (e.g. by attaching the lid 815 of each dose container 810 to the base 817 of each dose container 810) and the dose containers 810 can be labeled with individual barcodes (e.g., on the lid 815). The tray 818 can be separated into strips 816 for loading into the removable basket 819. For example, FIG. 8B is a bottom view of a strip 816 after separation from the remaining strips 816 of the tray 818. As shown in FIGS. 8A and 8B, in some embodiments, the tray 818 can be formed of a number of strips 816, the bases 817 of the dose containers 810 in each strip 816 being a unitary structure separable by a medication dispensing device. Additionally, as shown in FIG. 8A, the strips 816 of the tray 818 can be attached via connectors 823 prior to being separated for loading into the basket 819.

Each of the dose containers 810 can be shaped as a plastic cup with rounded edges to prevent medication from sticking to the sides and/or bottom of the cup and to allow easy removal of medication by the user. One or more sides of each of the dose containers 810 can be rounded to allow medications to be easily poured into the hand or individually removed. In some embodiments, each of the dose containers 810 can be formed from a material that is lightweight and rigid such as, for example, plastics. In some embodiments, each of the dose containers 810 can include at least one transparent portion, for example, the bases 817 can be transparent, such that the contents of the interior region of each of the dose containers 810 can be viewed from outside of each of the dose containers 810.

Each of the dose containers 810 can have unique identifiers, for example, labels, tags or unique shapes to correspond to at least one day of the week. In other embodiments, each of the dose containers 810 can have covers that can include unique identifiers such as, for example, labels or tags to indicate the day of the week on which the medication is to be taken. For example, each of the dose containers 810 can have a barcode (not shown) printed on the lid 815 of the dose container 810. The barcode can contain information related to the dispensing of each the dose container 810, as described above with reference to dose container 110 and dose container 210.

FIGS. 8C and 8D are a perspective view and a top view of a medication dispensing device 800 in a first configuration and a second configuration, respectively. The medication dispensing device 800 can be similar in structure and function to any of the medication dispensing devices described herein, such as the medication dispensing device 200. As shown in FIG. 8C, the removable basket 819 can be separated from the medication dispensing device 800 via an opening 875 in the medication dispensing device 800. When in the first configuration in which the basket 819 is removed from the medication dispensing device 800, the basket 819 can be loaded with a number of vertically-stacked strips 816. As shown in FIG. 8D, the basket 819 can then be inserted through the opening 875 into a second configuration within the medication dispensing device 800. The basket 819 can be repeatedly removed from and reinserted into the medication dispensing device 800 to add and/or remove strips 816.

Although the strips 816 are shown as including four dose containers 810, the strips 816 can include any number of dose containers 810 appropriate for a particular user's treatment regimen. Additionally, the basket 819 and the medication dispensing device 800 can be configured to receive any number of strips 816 and/or dose containers 810 appropriate for a particular user's treatment regimen. For example, the dose containers 810 can be arranged in a “number of doses per day” by “day of the week” (e.g., N×7) array, with each dosage in an individual dose container. Said another way, the dose containers 810 can be arranged to have dose containers, for example, in a 2 dose/day×7 days, 3 dose/day×7 days, or 4 dose/day×7 days dosing regimen.

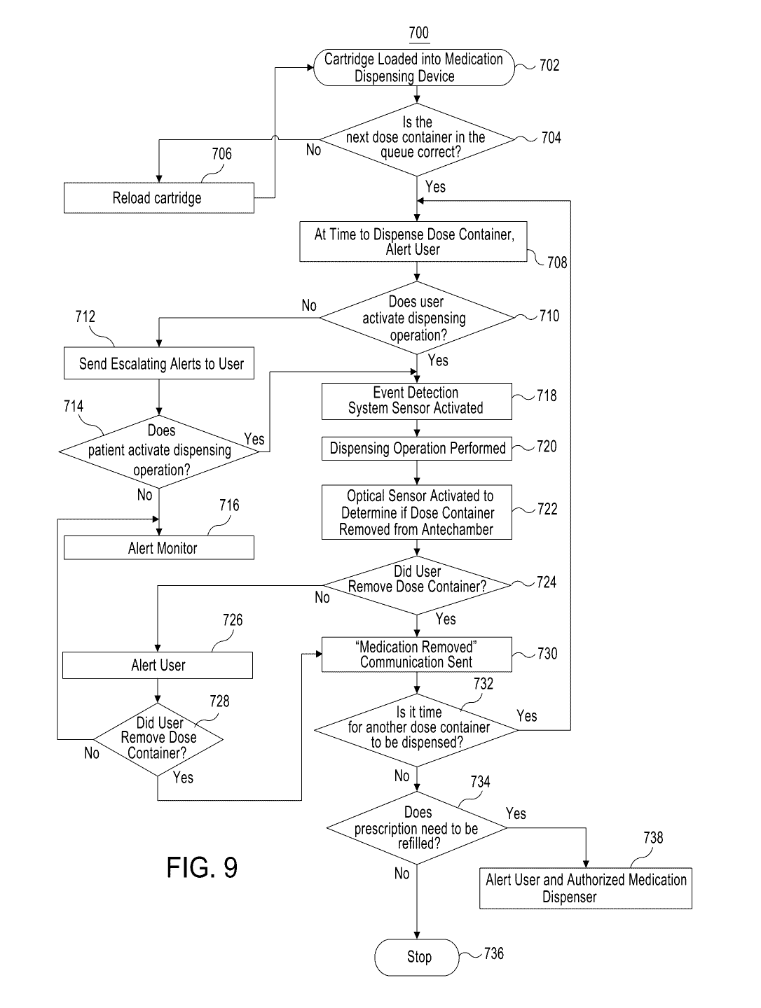

FIG. 9 illustrates a flow diagram showing an exemplary method 700 for monitoring and ensuring patient adherence to a prescribed medication regimen using any embodiment of the medication dispensing device described herein. First, a cartridge or a basket is loaded into a medication dispensing device, at 702. The cartridge or basket can be similar to cartridge 212 or basket 819, respectively, and will not be further described herein. A barcode reader determines whether the next dose container in the queue is correct, at 704. If the next dose container is not correct, then the cartridge or basket needs to be reloaded and the process restarted, at 706. If the next dose container is correct, then when it is time for the user to dispense the dose container (e.g. time for a patient to take the prescribed dose), the medication dispensing device notifies the user that it is time to take the particular dose using audio, visual, and/or tactile alerts, as described herein, at 708. The user either activates or fails to activate a dispensing operation of the medication dispensing device, at 710. The dispensing operation can include an indexing operation and a cutting operation. If the user does not activate the dispensing operation (e.g., the lever has not been pressed), the medication dispensing device sends escalating alerts to the patient (e.g. escalating alarm, blink LEDs, visual and/or audio message), at 712. The medication dispensing device then determines if the user activates the dispensing operation or not, at 714. If the user still does not activate the dispensing operation within a predetermined time period, an alert is sent to a monitor (e.g. a family member, care giver, call center, doctor, pharmacy, or clinical trial manage), at 716.

If the user activated the dispensing operation within the predetermined time period, an event detection system is activated, at 718, and the sensors detect an event, such as, for example, if a dose container is removed from the medication dispensing device. The dispensing operation is performed, at 720. An optical sensor can be activated by the event detection system, at 722, to determine if a dose container is removed from the antechamber of the medication dispensing device, at 724. If the user did not remove the dose container from the antechamber, the medication dispensing device notifies the user that it is time to remove the dose container using audio, visual, and/or tactile alerts, as described herein, at 726. If the user does not remove the dose container within a predetermined time period, the monitor is alerted so that corrective action can be taken, at 716. Optionally, in some embodiments, the medication dispensing device can be configured so that if the dose container is not removed within a predetermined time period, the medication dispensing device can lock out the user from accessing the dose container in the antechamber and/or can open a trap door in the antechamber so that the dose container falls into a receptacle below the antechamber. As a result, a patient can be prevented from taking the dose outside of the appropriate timeframe. Additionally, if a dose is missed, the missed dose container will not obstruct the delivery of the next dose container. The medication dispensing device can include a manual override procedure and associated components in order to remove the missed dose container from the receptacle below the antechamber.

Alternatively, in some embodiments, the medication dispensing device can be configured to automatically dispense a dose container into an antechamber of the medication dispensing device at the appropriate time to dispense the dose container. When it is the appropriate time, an indexing assembly of the medication dispensing device can move a dose container into the antechamber. The medication dispensing device can then notify the user via audio, visual, and/or tactile alerts, as described herein, that it is time to initiate a cutting operation in order to separate the dose container in the antechamber from any remaining dose containers on the strip. If the user does not initiate the cutting operation (e.g., the lever has not been pressed), the medication dispensing device can send escalating alerts to the patient (e.g. escalating alarm, blink LEDs, visual and/or audio message). The medication dispensing device can then determine if the user activates the cutting operation or not. If the user does not activate the cutting operation within a predetermined time period, an alert is sent to a monitor (e.g. a family member, care giver, call center, doctor, pharmacy, or clinical trial manage). If the user activates the cutting operation within the predetermined time period, the optical sensor can be activated by the event detection system to determine if the dose container is removed from the antechamber, and the method continues with step 724 as described above.

Once it is determined that the user removed the dose container, a “Medication Removed” communication is sent to the monitor, at 730. Next, the control unit will determine if it is time for another dose container to be dispensed, at 732. For example, the user may require more medication than can fit in one dose container or may be removing multiple doses for a weekend trip. If it is time for another dose container to be dispensed, then the process returns to the step of alerting the user that it is time to dispense a dose container, at 708. Alternatively, although not shown in FIG. 9, the medication dispensing device can be configured to automatically dispense the next dose container if it is the appropriate time. In this case, rather than returning to step 708, the method can begin the dispensing operation, at 720.

If no more dose containers are scheduled to be dispensed at the time, the barcode scanner will read the barcode associated with the next dose container in the queue and determine if the prescription needs to be refilled, at 734. If the medication dispensing device does not need to be refilled, then the process ends, at 736. If the medication dispensing device needs to be refilled with a new cartridge or basket, then the medication dispensing device communicates this information to the user and/or an authorized medication dispenser, e.g. pharmacy, doctor, clinical trial manager, at 738. The barcodes on the dose containers can be configured to indicate that a prescription refill is necessary when there is a particular number of dose containers remaining in the medication dispensing device. For example, the barcode on the dose containers can indicate that a prescription refill is necessary four days before the medication dispensing device is empty. Additionally, the barcodes on the dose containers can be configured to indicate that a cartridge or basket reload is necessary when there is a particular number of dose containers remaining in the medication dispensing device. For example, the barcode on the dose containers can indicate to the user that a new cartridge or basket of dose containers needs to be installed twenty-four hours before the medication dispensing device is empty.

While various embodiments of the system, methods and devices have be described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modifications are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combinations of components, other embodiments are possible having any combination or sub-combination of any features and/or components from any of the embodiments described herein. In addition, the specific configurations of the various components can also be varied. For example, the size and specific shape of the various components can be different than the embodiments shown, while still providing the functions as described herein.

1. A medication dispensing device, comprising:
a housing defining an inner volume configured to receive a plurality of dose containers, each of the plurality of dose containers defining an interior region configured to contain a plurality of individual medications;
a dispensing mechanism configured to dispense a dose container at a predetermined time based on a prescribed treatment regimen;
an event detection system including a plurality of sensors, the plurality of sensors configured to detect a change in status of at least one of the medication dispensing device and the plurality of dose containers; and
a control unit configured to operate the dispensing mechanism and the event detection system, and to communicate with at least one of a remote device and a user.

2. The medication dispensing device of claim 1, wherein the housing defines an antechamber and the dispensing mechanism is configured to dispense the dose container from the inner volume to the antechamber.

3. The medication dispensing device of claim 2, wherein the antechamber includes a light that illuminates when the dose container is ready to be removed from the antechamber.

4. The medication dispensing device of claim 2, wherein the antechamber is enclosed by a door.

5. The medication dispensing device of claim 4, further comprising:
a locking assembly operable coupled to the door and configured to control access to the antechamber.

6. The medication dispensing device of claim 1, further comprising:
at least one of a lever and a push button configured to actuate a dispensing operation.

7. The medication dispensing device of claim 6, wherein the dispensing operation includes at least one of a indexing operation, a cutting operation, and a door opening operation.

8. The medication dispensing device of claim 2, wherein the dispensing mechanism includes an indexing assembly configured to move the dose container into the antechamber.

9. The medication dispensing device of claim 8, wherein the indexing assembly includes at least one of a drive motor, a lead screw, and a drive block.

10. The medication dispensing device of claim 1, further comprising:
a scanner configured to read a unique identifier on a label of the dose container, the unique identifier associated with the prescribed treatment regimen.

11. The medication dispensing device of claim 1, wherein the dispensing mechanism includes a cutting assembly configured to separate the dose container from the plurality of dose containers.

12. The medication dispensing device of claim 2, wherein the event detection system includes an optical sensor configured to sense the dose container within the antechamber and communicate sensed information to the control unit.

13. The medication dispensing device of claim 1, further comprising:
a notification system configured to produce at least one of an alarm, an audible sound, a signal beep, and a verbal communication to notify the user.

14. A medication adherence system, comprising:
a plurality of dose containers, each of the plurality of dose containers defining an interior region configured to contain a plurality of individual medications;
a medication dispensing device configured to receive the plurality of dose containers, the medication dispensing device including a dispensing mechanism configured to dispense a dose container at a predetermined time based on a prescribed treatment regimen; and
a remote monitor configured to receive a change in status of at least one of the medication dispensing device and the plurality of dose containers.

15. The medication adherence system of claim 14, wherein the medication dispensing device includes an event detection system configured to detect the change in status of the medication dispensing device and/or the plurality of dose containers.

16. The medication adherence system of claim 14, wherein the medication dispensing device includes a control unit configured to operate the dispensing mechanism and the event detection system, and to communicate with at least one of the remote monitor and a user.

17. The medication adherence system of claim 14, wherein each of the plurality of dose containers includes a unique identifier.

18. The medication adherence system of claim 17, wherein the unique identifier is at least one of barcode, a QR code, and an RFID tag.

19. A method, comprising:
receiving a plurality of dose containers, each of the plurality of dose containers defining an interior region configured to contain a plurality of individual medications;
inserting the plurality of dose containers into a medication dispensing device, the medication dispensing device, the medication dispensing device including a dispensing mechanism configured to dispense a dose container at a predetermined time based on a prescribed treatment regimen; and
removing the dose container from the medication dispensing device.

20. The method of claim 19, wherein the medication dispensing device includes a notification system configured to communicate an alert to a user when the dose container is dispensed.

21. The method of claim 19, further comprising:
communicating information of dose container removal with a monitor.

22. The method of claim 19, wherein the medication dispensing device includes an antechamber and the dispensing mechanism is configured to dispense the dose container to the antechamber at the predetermined time.

23. The method of claim 22, wherein removing the dose container from the medication dispensing device includes opening a door to the antechamber and removing the dose container from the antechamber.
